(19) United States
(12) Patent Application Publication
(10) Pub. No.: US 2008/0156595 A1
(43) Pub. Date: Jul. 3, 2008

(54) DISC BRAKE APPARATUS OF OPPOSED-PISTON TYPE

(76) Inventor: Yoshiki MATSUZAKI, Farmington Hills, MI (US)

Correspondence Address: BUCHANAN, INGERSOLL & ROONEY PC, POST OFFICE BOX 1404, ALEXANDRIA, VA, 22313-1404, US

(21) Appl. No.: 11/963,341

(22) Filed: Dec. 21, 2007

(30) Foreign Application Priority Data
Dec. 28, 2006 (JP) 2006-354672

(51) Int. Cl. F16D 55/02

(52) U.S. Cl. 188/73.37

(57) ABSTRACT

An object of the invention is to suppress an unnecessary movement of pads, which are respectively arranged at both sides of a disc rotor, and also suppress generation of brake noise and abnormal noise. A pair of torque frames are firmly fixed to a caliper of an opposed-piston type disc brake apparatus. Pad spaces are formed in the respective torque frames, in order to assemble pads such that movement of the pads is restricted in radial and rotational direction of a rotor disc but movement of the pads is accepted in an axial direction of the rotor disc. A braking force is generated when the pads are pushed in the axial direction, and a reaction force of the braking force is received by the caliper via the torque frames.

### CROSS REFERENCE TO RELATED APPLICATION

This application is based on Japanese Patent Application No. 2006-354672 filed on Dec. 28, 2006, the disclosure of which is incorporated herein by reference.

### FIELD OF THE INVENTION

The present invention relates to a disc brake apparatus of an opposed-piton type for a vehicle. In particular, the present invention relates to a disc brake apparatus, which has cylinders formed in an inner portion and an outer portion of a caliper such that the inner and outer portions straddle a disc rotor and oppose to each other, pistons assembled into the cylinders for pushing a pair of pads in an axial direction of the disc rotor to generate a braking force, a reaction force of which is received and supported by the caliper.

### BACKGROUND OF THE INVENTION

A disc brake apparatus of this kind is known in the art, for example, as disclosed in Japanese Patent Publication H7-167172 or US Patent Application Publication No.: US 2004/0154882 A1. In the disc brake apparatus of an opposed-piston type, a pad pin is provided to extend between an inner portion and an outer portion of a caliper in an axial direction of a disc rotor. The pad pin is loosely inserted through a pin hole formed in a backing plate of a pad to hold the pad in a position, so that the pad is movable in the axial direction, a circumferential direction and a radial direction of the disc rotor. When the pads are pushed in the axial direction, the pads slide on the disc rotor to apply a braking force to the disc rotor. A reaction force of the braking force is then received by a torque receiving portion of the caliper, which is brought into contact with a circumferential end portion of the backing plate of the pad via the backing plate.

In the above disc brake apparatus, as explained, the pad pin is loosely inserted through the pin hole formed in the backing plate of the pad, to movably hold the pad in the axial direction, the circumferential direction and the radial direction of the disc rotor. Therefore, in the above disc brake apparatus, a spring member is provided to restrict an unnecessary movement of the pad with respect to the pad pin. It is, however, a problem that a brake noise or an abnormal noise (Rattle sound, or squeaking noise) may be generated due to the above structure.

In the above conventional disc brake apparatus (US 2004/0154882 A1), the pads are divided into two pad pieces in the rotational direction of the disc rotor on each side of the inner and outer portions of the caliper. It is, therefore, necessary to provide two torque receiving portions on the caliper, for respectively receiving the reaction force of the braking force transmitted from the backing plates of the respective pads. As a result, a structure of the caliper becomes complicated and a cost thereof is correspondingly increased.

### SUMMARY OF THE INVENTION

The present invention is made in view of the foregoing problems, and has an object to provide a disc brake apparatus of an opposed-piston type for a vehicle, which is simple in structure and low in cost, and which prevents the generation of the braking noise or the abnormal noise.

According to one of the features of the present invention, a torque frame is firmly fixed to a caliper, a pad space is formed in the torque frame for accommodating a pad in such a manner that a movement of the pad is restricted in the radial and circumferential (rotational) direction of the disc rotor but the movement of the pad is accepted in the axial direction of the disc rotor, and a reaction force of a braking force is received by the caliper via the torque frame.

According to a disc brake apparatus of the present invention, a pad can be assembled to a pad space of a torque frame such that movement of the pad is restricted in radial and rotational direction of a disc rotor but the movement of the pad is accepted in an axial direction of the disc rotor. As a result, such a spring member for suppressing an unnecessary movement of the pad is not required. In addition, it is possible to suppress the generation of brake noise or abnormal noise (Rattle sound, or squeaking noise).

Furthermore, according to the disc brake apparatus of the opposed-piston type of the present invention, each of the pads is assembled into the respective pad spaces formed in the torque frames. It is, therefore, easy to change a holding structure for the pads, by changing the outer shape of the pads and correspondingly changing the shape of the pad spaces formed in the torque frames. As a result, in addition that an optimization for the shape of the pads can be easily done, it is easy to cope with a design change, according to which the positions of the pads should be offset from the cylinders in the circumferential direction of the disc rotor. Namely, the above design change can be easily done by offsetting the positions for the pad spaces formed in the torque frames in the circumferential direction of the disc rotor. Accordingly, it becomes possible to achieve standardization for the calipers to be applied to the right and left vehicle wheels.

Furthermore, according to the present invention, a clearance between the pad and the torque frame is made smaller than a clearance between the piston and the cylinder. As a result, the clearance between the piston and the cylinder can be maintained, and the axial movement of the piston is not restricted by the cylinder during the braking operation. Therefore, each of the pads is properly pushed by the pistons, so that surface pressure by the pads at the sliding surfaces of the disc rotor becomes more stable to improve the braking operation.

Furthermore, according to the present invention, the material for the torque frames is preferably the same to that for the backing plates for the pads. As a result, an initial fit-in characteristic between the torque frames and the backing plates of the pads is improved to decrease sliding resistance of the backing plates of the pads against the torque frames at an initial stage for use of the braking apparatus.

Furthermore, according to the present invention, a center bridge portion is provided for connecting the inner and outer portions of the caliper at the respective center portions, and the torque frames may be fixed to the caliper by the center bridge portion. In such a case, the center bridge portion is detachably fixed to the caliper, so that the torque frames can be detached from the caliper together with the pads, when the center bridge portion is detached from the caliper. As a result, exchangeability for the pads is increased.

Furthermore, according to the present invention, a number of cylinders respectively formed in the inner and outer portions of the caliper is two or more than two. Those plurality of cylinders are arranged in the rotational direction of the disc rotor, wherein the pistons are assembled into the respective cylinders. In such a case, a partitioning wall is provided to divide the pad space into two smaller pad spaces in the rotational direction of the disc rotor, and the pads, which are pushed by the pistons in the axial direction of the disc rotor, are respectively assembled into the divided pad spaces.

According to the above feature, a possible disadvantage for one pad space (e.g. a warp of the pad due to a large-size, a decrease of the braking force, a disproportional abrasion of the pad to be caused by the warp, etc) can be overcome. In addition, since the partitioning wall provided in each of the torque frames operates as a torque receiving portion, it is not necessary to change the design of the caliper, even when the pad spaces are respectively divided into two (or more than two) smaller pad spaces.

Furthermore, according to the present invention, the torque frame may be formed by multiple pieces (two or more than two pieces), which can be separated and assembled in the radial direction of the disc rotor. According to the above feature, the pads fixed to the torque frames can be exchanged, when the torque frames are separated in the radial direction of the disc rotor. As a result, the exchangeability of the pads is extremely improved.

Furthermore, according to the present invention, it may be preferable to treat a coating (e.g. DLC coating: Diamond Like Carbon coating) at the pad spaces of the torque frames, wherein the coating has low coefficient of friction, abrasion resistance, and anti-corrosion characteristics. According to such coating, a slipping performance between the torque frame and the pad as well as durability can be improved.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a disc brake apparatus of an opposed-piston type for a vehicle according to an embodiment of the present invention;

FIG. 2 is a cross sectional view taken along a line II-II in FIG. 1;

FIG. 3 is a cross sectional view taken along a line III-III in FIG. 1;

FIG. 4 is a front view showing a variation of a torque frame according to a second embodiment;

FIG. 5 is a front view showing a variation of a torque frame according to a third embodiment; and

FIGS. 6A and 6B are front views respectively showing variations of a torque frame according to a fourth embodiment.

### DETAILED DESCRIPTION OF THE PREFERRED EMBODIMENTS

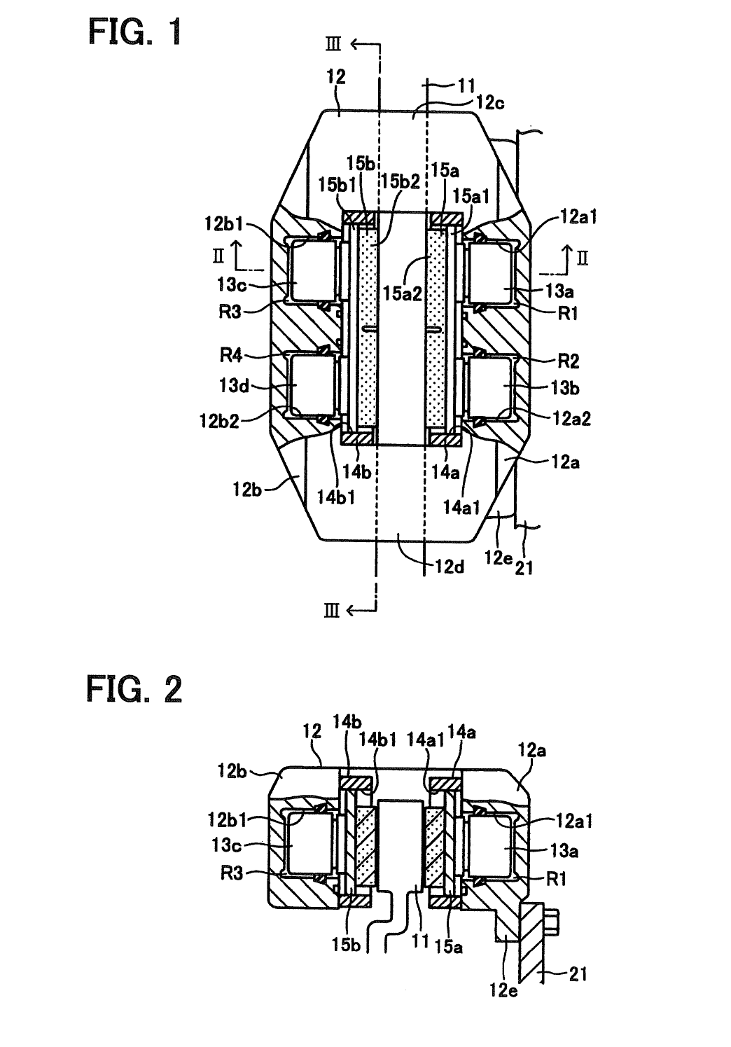

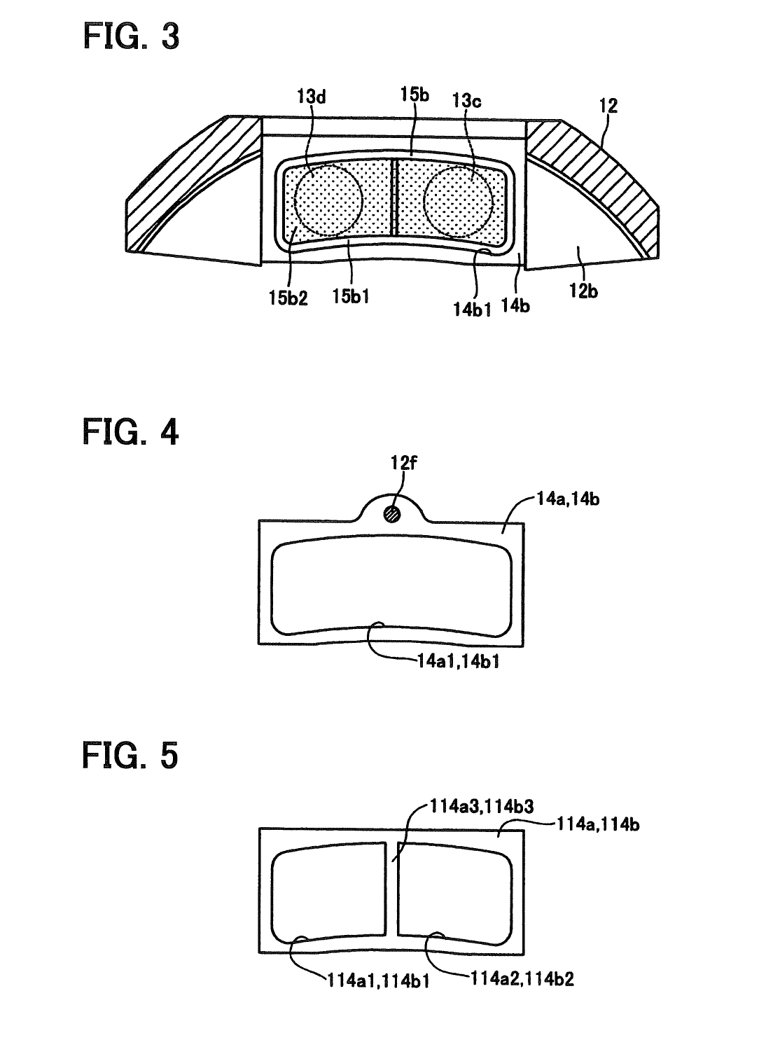

An embodiment of the present invention will be explained with reference to the attached drawings. FIGS. 1 to 3 schematically show the embodiment of the present invention, in which the present invention is applied to a disc brake apparatus of an opposed-piston type for a vehicle. The disc brake apparatus has a disc rotor 11 rotated together with a vehicle wheel, a caliper 12 straddling a part of the disc rotor 11, four pistons 13a to 13d assembled into the caliper 12, two torque frames 14a and 14b, and two pads 15a and 15b.

The caliper 12 has an inner portion 12a and an outer portion 12b, which straddle the part of the disc rotor 11 and respectively oppose to each other. The caliper 12 also has a pair of bridge portions 12c and 12d connecting the inner and outer portions 12a and 12b with each other. A pair of cylinders 12a1 and 12a2 and another pair of cylinders 12b1 and 12b2 are respectively formed in the inner and outer portions 12a and 12b in such a manner that the cylinders 12a1, 12a2, 12b1 and 12b2 are arranged at a predetermined distance in a circumferential direction (a rotational direction) of the disc rotor 11. The cylinders 12a1 and 12b1 are coaxially arranged with each other, whereas the cylinders 12a2 and 12b2 are likewise coaxially arranged with each other, so that the cylinders 12a1 and 12b1 and the cylinders 12a2 and 12b2 are opposing to each other in an axial direction of the disc rotor 11. A fixing portion 12e, which extends from the inner portion 12a in a radial direction of the disc rotor 11, is formed with the caliper 12, so that the caliper 12 is fixed to a mounting portion 21 of a vehicle body.

Each of the pistons 13a and 13b pushes the pad 15a of the inner side toward the disc rotor 11 in the axial direction of the disc rotor 11. Each of the pistons 13a and 13b is fluid-tightly assembled into the respective cylinders 12a1 and 12a2, such that the pistons 13a and 13b are movable in the respective cylinders 12a1 and 12a2 in the axial direction of the disc rotor 11. Oil chambers R1 and R2 are respectively formed in the cylinders 12a1 and 12a2. Oil pressure from a brake master cylinder (not shown) is applied to or released from the respective oil chambers R1 and R2.

In a similar manner, each of the pistons 13c and 13d pushes the pad 15b of the outer side toward the disc rotor 11 in the axial direction of the disc rotor 11. Each of the pistons 13c and 13d is fluid-tightly assembled into the respective cylinders 12b1 and 12b2, such that the pistons 13c and 13d are movable in the respective cylinders 12b1 and 12b2 in the axial direction of the disc rotor 11. Oil chambers R3 and R4 are respectively formed in the cylinders 12b1 and 12b2. Oil pressure from the brake master cylinder (not shown) is applied to or released from the respective oil chambers R3 and R4.

The torque frame 14a of the inner side is formed into an approximately rectangular shape, wherein a length of the frame in the radial direction of the disc rotor 11 is shorter than that of the frame in the circumferential direction of the disc rotor 11. The torque frame 14a is firmly attached to the inner portion 12a of the caliper 12 on the inner side by means of a suitable fixing means (e.g. a single or a combination of fixing by a press-fitting, fixing by adhesive material, fixing by screws, and so on). A pad space 14a1 is formed in the torque frame 14a of the inner side, so that the pad 15a of the inner side is assembled into the pad space 14a1 wherein a movement of the pad 15a is restricted in the radial direction and circumferential (rotational) direction of the disc rotor 11 but the movement of the pad 15a is accepted in the axial direction of the disc rotor 11.

The torque frame 14b of the outer side is formed from the same material (either from the same metal or nonmetal material) to the torque frame 14a and formed into the same shape to the torque frame 14a of the inner side. In a similar manner to the torque frame 14a, the torque frame 14b is firmly attached to the outer portion 12b of the caliper 12 on the outer side by means of a suitable fixing means (e.g. a single or a combination of fixing by a press-fitting, fixing by adhesive material, fixing by screws, and so on). A pad space 14b1 is formed in the torque frame 14b of the outer side, so that the pad 15b of the outer side is assembled into the pad space 14b1 wherein a movement of the pad 15b is restricted in the radial direction and circumferential (rotational) direction of the disc rotor 11 but the movement of the pad 15b is accepted in the axial direction of the disc rotor 11.

The pad 15a of the inner side is composed of a backing plate 15a1, which is made of the same material to the torque frame 14a of the inner side, and a lining 15a2 fixed to the backing plate 15a1. The backing plate 15a1 is assembled into the pad space 14a1 of the torque frame 14a of the inner side with a small clearance, wherein the small clearance is less than clearances respectively formed between the pistons 13a and 13b and the cylinders 12a1 and 12a2.

In a similar manner to the pad 15a of the inner side, the pad 15b of the outer side is composed of a backing plate 15b1, which is made of the same material to the torque frame 14b of the outer side, and a lining 15b2 fixed to the backing plate 15b1. The backing plate 15b1 is assembled into the pad space 14b1 of the torque frame 14b of the outer side with a small clearance, wherein the small clearance is less than clearances respectively formed between the pistons 13c and 13d and the cylinders 12b1 and 12b2.

In the embodiment having the structure explained above, when the oil pressure is applied to the respective oil chambers R1 to R4 from the brake master cylinder, the respective pistons 13a and 13b as well as 13c and 13d push the pads 15a and 15b toward the disc rotor 11, so that each of the pads 15a and 15b slides on the disc rotor 11 to apply braking force thereto. A reaction force of the braking force generated in the above operation is held up by the caliper 12, to which the reaction force of the braking force is transmitted via the respective torque frames 14a and 14b. When working fluid is discharged from the oil chambers R1 to R4 to the brake master cylinder, the braking force to the disc rotor 11 is released.

According to the above embodiment, each of the pads 15a and 15b can be assembled into the respective pad spaces 14a1 and 14b1 of the torque frames 14a and 14b, such that the movement of the pad 15a, 15b in the radial direction and circumferential (rotational) direction of the disc rotor 11 is restricted, whereas the movement of the pad 15a, 15b in the axial direction of the disc rotor 11 is accepted. Namely, the pad 15a, 15b is assembled into the pad space 14a1, 14b1, so that the pad 15a, 15b may not unnecessarily move in the radial direction and circumferential (rotational) direction of the disc rotor 11. As a result, a spring member for suppressing the unnecessary movement of the pad 15a, 15b is not required, it becomes possible to suppress a generation of brake noise, and it is further possible to suppress a generation of abnormal noise (Rattle sound, or squeaking noise).

Furthermore, according to the above embodiment, each of the pads 15a and 15b is assembled into the respective spaces 14a1 and 14b1 formed in the torque frames 14a and 14b. It is, therefore, easy to change a holding structure for the pads 15a and 15b, by changing the outer shape of the pads 15a and 15b and correspondingly changing the shape of the spaces 14a1 and 14b1 formed in the torque frames 14a and 14b. As a result, in addition to that an optimization for the shape of the pads can be easily done, it is easy to cope with a design change, according to which the positions of the pads 15a and 15b should be offset from the cylinders 12a1, 12a2, 12b1 an 12b2 in the circumferential direction of the disc rotor 11. Namely, the above design change can be easily done by offsetting the positions for the spaces 14a1 and 14b1 formed in the torque frames 14a and 14b in the circumferential direction of the disc rotor 11. Accordingly, it becomes possible to achieve standardization for the calipers 12 to be applied to the right and left vehicle wheels.

According to the above embodiment, the clearance between the pad 15a, 15b and the torque frame 14a, 14b is made smaller than the clearance between the piston 13a, 13b, 13c, 13d and the cylinder 12a1, 12a2, 12b1, 12b2. As a result, the clearance between the piston 13a, 13b, 13c, 13d and the cylinder 12a1, 12a2, 12b1, 12b2 can be maintained, and the axial movement of the piston 13a, 13b, 13c, 13d is not restricted by the cylinder 12a1, 12a2, 12b1, 12b2 during the braking operation. Therefore, each of the pads 15a and 15b is properly pushed by the pistons 13a, 13b, 13c, and 13d, so that surface pressure by the pads 15a and 15b at the sliding surfaces of the disc rotor 11 becomes more stable to improve the braking operation.

Furthermore, according to the above embodiment, the material for the torque frames 14a and 14b is the same to that for the backing plates 15a1 and 15b1 for the pads 15a and 15b. Accordingly, an initial fit-in characteristic between the torque frames 14a and 14b and the backing plates 15a1 and 15b1 for the pads 15a and 15b is improved to decrease sliding resistance of the backing plates 15a1 and 15b1 of the pads 15a and 15b against the torque frames 14a and 14b at an initial stage for use of the braking apparatus.

Furthermore, according to the above embodiment, the caliper 12 has the inner and outer portions 12a and 12b, which straddle the part of the disc rotor 11 and oppose to each other. The caliper 12 further has the pair of bridge portions 12c and 12d connecting the inner and outer portions 12a and 12b with each other, wherein the bridge portions 12c and 12d are integrally formed with the inner and outer portions 12a and 12b. However, the caliper 12 may be formed in such a manner that each of the inner and outer portions 12a and 12b is divided into two parts along a line parallel to an axis of the disc rotor 11, and those two parts may be connected with each other by a plurality of bridge bolts.

Furthermore, according to the above embodiment, the caliper 12 is explained as such a caliper in which the inner and outer portions 12a and 12b are connected with each other by the pair of bridge portions 12c and 12d formed at both ends of the inner and outer portions 12a and 12b, but not connected with each other by a center bridge portion. The present invention can be, however, also applied to such a caliper having the center bridge portion, which connects the inner and outer portions 12a and 12b with each other. In such a case, it is possible to fix the torque frames 14a and 14b to the caliper 12 by means of the center bridge portion (bridge bolt) 12f, as shown in FIG. 4. According to the modification of FIG. 4, the center bridge portion 12f is detachably fixed to the caliper 12, so that the torque frames 14a and 14b are also detachable from the caliper 12 together with the pads 15a and 15b. As a result, exchangeability for the pads is increased.

Furthermore, according to the above embodiment, one pad 15a (15b), two cylinders 12a1 and 12a2 (12b1 and 12b2) and two pistons 13a and 13b (13c and 13d) assembled into the cylinders are respectively provided in each of the inner and outer portions 12a and 12b of the caliper 12. However, the number of the cylinders and the pistons assembled into the cylinders may be changed to one or more than two. Alternatively, the number of pads respective provided in the inner and outer portions may be changed to more than two.

In the case that two pieces of the pads are used for the inner and outer portions 12a and 12b of the caliper 12, a torque frame 114a (114b) shown in FIG. 5 may be used. The outer shape of the torque frame 114a (114b) is formed into the same shape of the torque frame 14a (14b). The pad space 14a1 (14b1) is divided into two smaller pad spaces 114a1 and 114a2 (114b1 and 114b2) in the rotational direction of the disc rotor 11. A partitioning wall 114a3 (114b3) is provided between the divided pad spaces 114a1 and 114a2 (114b1 and 114b2). Pads (not shown), which are pushed by the pistons 13a to 13d in the axial direction of the disc rotor 11 and toward the disc rotor 11, are respectively assembled into the divided pad spaces 114a1, 114a2, 114b1 and 114b2, wherein the movement of each pad is restricted in the radial direction and circumferential (rotational) direction of the disc rotor 11 but the movement of the pad is accepted in the axial direction of the disc rotor 11.

According to the above embodiment (the divided pad spaces), a possible disadvantage for one space for the pad (e.g. a warp of the pad due to a large-size, a decrease of the braking force, a disproportional abrasion of the pad to be caused by the warp, etc) can be overcome. In addition, the partitioning wall 114a3 (114b3) provided in each of the torque frames 114a and 114b operates as a torque receiving portion. It is not necessary to change the design of the caliper 12, even when the pad spaces are respectively divided into two smaller pad spaces.

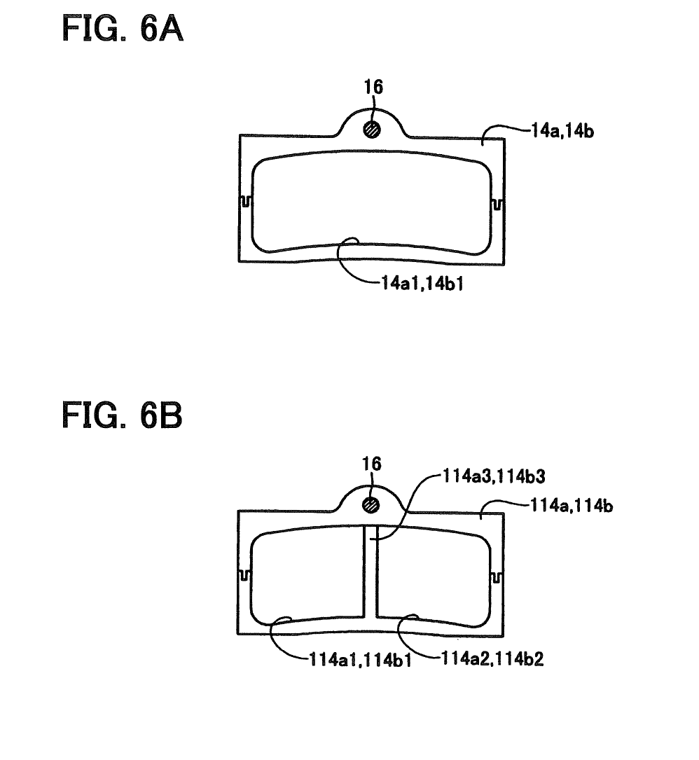

According to the above embodiment, each of the torque frames 14a and 14b is formed into the rectangular shape and formed by one single piece. However, as shown in FIG. 6A, the torque frame 14a (14b) may be formed by two frame pieces (or more than two pieces), which can be separated and assembled in the radial direction of the disc rotor 11. In the similar manner, as shown in FIG. 6B the torque frame 114a (114b) having the partitioning wall 114a3 (114b3) may be formed by two frame pieces (or more than two pieces), which can be separated and assembled in the radial direction of the disc rotor 11. According to the above modifications of the torque frames, the pads 15a and 15b can be exchanged when the torque frames are separated in the radial direction of the disc rotor 11, more exactly when the upper frame pieces (outer frame pieces in the radial direction) of the torque frames 14a, 14b, 114a and 114b are detached from the caliper 12. As above, the exchangeability of the pads is extremely improved. In FIGS. 6A and 6B, the outer frame pieces in the radial direction of the disc rotor 11 correspond to the frame pieces which are shown at upper portions of the respective drawings. The upper portions of the torque frames are detachably fixed to the caliper 12 by means of the bolt 16 (the bolt 16 may be used as the center bridge portion), whereas the lower portions of the torque frames are firmly fixed to the caliper 12 by means of any suitable fixing means.

According to the above embodiment, the material for the torque frames 14a and 14b is the same to that for the backing plates 15a1 and 15b1 for the pads 15a and 15b. However, the torque frames and the backing plates may be made of different materials. Furthermore, the backing plates 15a1 and 15b1 may be removed from the pads 15a and 15b.

It may be also possible to treat a coating (e.g. DLC coating: Diamond Like Carbon coating) at the pad spaces of the torque frames 14a and 14b, wherein the coating has low coefficient of friction, abrasion resistance, and anti-corrosion characteristics. According to such coating, a slipping performance between the torque frame and the pad as well as durability can be improved.

What is claimed is:

1. A disc brake apparatus for a vehicle comprising:
a caliper having an inner portion and an outer portion, which straddle a disc rotor and oppose to each other;
cylinders formed in the inner and outer portions of the caliper;
pistons respectively assembled into the cylinders such that each of the pistons is movable in the respective cylinders in an axial direction of the disc rotor;
pads connected to the pistons such that the pads are pushed by the pistons toward the disc rotor, wherein the pads slide on the disc rotor to generate a braking force, a reaction force of which is received by the caliper,
wherein the disc brake apparatus further comprises:
torque frames firmly fixed to the caliper; and
pad spaces respectively formed in the torque frames for accommodating the pads, such that a movement of each pad is restricted in a radial direction and a rotational direction of the disc rotor, whereas the movement of the pad is accepted in the axial direction of the disc rotor, wherein the reaction force of the braking force is received by the caliper via the torque frames.

2. A disc brake apparatus according to claim 1, wherein
a clearance between the pad and the torque frame is made smaller than a clearance between the piston and the cylinder.

3. A disc brake apparatus according to claim 1, wherein
the torque frame and a backing plate of the pad are made of the same material.

4. A disc brake apparatus according to claim 1, further comprising:
a center bridge for connecting a center portion of the inner portion with a center portion of the outer portion,
wherein the center bridge firmly fixes the torque frames to the caliper.

5. A disc brake apparatus according to claim 1, wherein
the number of cylinders respectively formed in the inner and outer portions is more than two,
the multiple cylinders are arranged in the rotational direction of the disc rotor, and
the pistons are respectively assembled into the cylinders.

6. A disc brake apparatus according to claim 5, wherein
a partitioning wall is formed in the torque frame for dividing the pad space into multiple smaller pad spaces in the rotational direction of the disc rotor, and
the pads assembled into the respective smaller pad spaces, so that the respective pads are pushed in the axial direction of the disc rotor and toward the disc rotor.

7. A disc brake apparatus according to claim 1, wherein
each of the torque frames is formed by multiple pieces, which can be separated from and connected to each other in the radial direction of the disc rotor.

8. A disc brake apparatus according to claim 1, wherein
a coating having low coefficient of friction, abrasion resistance and anti-corrosion characteristics is treated at least at the pad spaces.
